(19) United States
(12) Patent Application Publication
(10) Pub. No.: US 2017/0032164 A1
(43) Pub. Date: Feb. 2, 2017

(54) ELECTRONIC DEVICE, DISPLAY SCREEN, AND PANEL

(71) Applicants: BEIJING LENOVO SOFTWARE LTD., Beijing (CN); LENOVO (BEIJING) CO., LTD., Beijing (CN)

(72) Inventors: Heng LIU, Beijing (CN); Chunhui SUN, Beijing (CN)

(73) Assignees: BEIJING LENOVO SOFTWARE LTD., Beijing (CN); LENOVO (BEIJING) CO., LTD., Beijing (CN)

(21) Appl. No.: 14/933,562

(22) Filed: Nov. 5, 2015

(30) Foreign Application Priority Data
Jul. 27, 2015 (CN) 201510445455.9

(51) Int. Cl. G06K 9/00; G06F 3/041

(52) U.S. Cl. CPC G06K 9/0002; G06F 3/0412; G06F 2203/04111

(57) ABSTRACT

The embodiments of the present disclosure provide an electronic device, a display screen and a panel. The panel includes: a transparent substrate; a detection electrode and a fingerprint detection circuit which are arranged on the transparent substrate, wherein the detection electrode includes a fingerprint detection electrode, the fingerprint detection circuit being connected to the fingerprint detection electrode and configured to drive the fingerprint detection electrode for fingerprint identification. It can be seen that, the panel directly integrates a fingerprint detection electrode and a fingerprint detection circuit. Therefore, as compared with the prior art, the display screen or the electronic device with the panel does not need to have an opening on the panel, thereby eliminating the need for aligning the opening and a fingerprint identification chip, which can result in a simple process and a low cost.

### CROSS-REFERENCE TO RELATED APPLICATIONS

The present application claims priority to Chinese Patent Application No. 201510445455.9, filed with the State Intellectual Property Office of People's Republic of China on Jul. 27, 2015 titled “ELECTRONIC DEVICE, DISPLAY SCREEN, AND PANEL”, the content of which is incorporated herein by reference in its entirety.

### TECHNICAL FIELD

The present disclosure relates to the technical field of fingerprint detection, and in particular to an electronic device, a display screen and a panel.

### BACKGROUND

With the continuous developments in science and technology, an increasing number of electronic devices are being widely used in people's work and daily life, which brings great convenience to people's work and daily life. With the diversification of the functions of the electronic devices, in order to ensure information security, the electronic devices need to be capable of detecting fingerprints so that they have a fingerprint identification function.

To enable the fingerprint identification function for the electronic devices, conventional electronic devices utilizes an LGA (Land Grid Array) packaging technology, where a fingerprint identification chip is directly mounted onto a back plate of the electronic device, and a touch sensitive area is exposed at an opening located in the position of a main menu button of a panel of the electronic device, so that the fingerprint identification chip can perform fingerprint detection.

In order to implement the fingerprint identification function, in the conventional electronic device the panel and the back plate need to be correctly aligned, so that the opening on the panel and the fingerprint identification chip are aligned, which results in a complex process and a high cost.

### SUMMARY

In order to solve the above problem, the present disclosure provides an electronic device, a display screen and a panel, which can result in a simple process and a low cost.

For achieving the above objective, the present disclosure provides the technical solutions as follows.

A panel for an electronic device, the panel including: a transparent substrate; a detection electrode and a fingerprint detection circuit which are arranged on the transparent substrate, where the detection electrode includes a fingerprint detection electrode, the fingerprint detection circuit being connected to the fingerprint detection electrode and configured to drive the fingerprint detection electrode for fingerprint identification.

A display screen including a back plate and the panel mentioned above opposite to each other, and a display module arranged between the back plate and the panel.

An electronic device including the display screen mentioned above.

### BRIEF DESCRIPTION OF THE DRAWINGS

In order to more clearly illustrate the technical solutions in the embodiments of the present disclosure and in the prior art, accompanying drawings used in the description of the embodiments and the prior art will be introduced briefly. Clearly, the drawings introduced below are merely some of the embodiments of the present disclosure; those skilled in the art can obtain other drawings based on the drawings disclosed herein without inventive effort.

FIG. 1 is a schematic structural diagram of a panel according to an embodiment of the present disclosure;

FIG. 2 is a schematic structural diagram of a panel according to another embodiment of the present disclosure;

FIG. 3 is a schematic structural diagram of a fingerprint detection electrode according to an embodiment of the present disclosure;

FIG. 4 is a sectional view taken along a first direction X of FIG. 3; and

FIG. 5 is a schematic structural diagram of a display screen according to an embodiment of the present disclosure.

### DETAILED DESCRIPTION OF THE EMBODIMENTS

The technical solutions in the embodiments of the present disclosure will be clearly and completely described hereinafter in conjunction with the drawings in the embodiments of the present disclosure. Clearly, the described embodiments are only some of the embodiments of the present disclosure. Based on the embodiments disclosed herein, all those embodiments obtained without inventive effort by those skilled in the art shall fall within the protection scope of the present disclosure.

As described in background section, in order to implement the fingerprint identification function, in a conventional electronic device a fingerprint identification chip is arranged on the back plate, and an opening is located on the panel; therefore, during assembling the panel and the back plate need to be accurately aligned, which can result in a complex process and a high cost. In addition, the area of the opening needs to be about 1 cm² in order to realize fingerprint detection, which is relatively large, and may lead to breaking of the panel during the making of the opening; additionally, a relatively large opening may affect the mechanical performance of the panel so that the panel is easily broken during use.

In order to solve the above problem, the present disclosure provides a panel for an electronic device. The panel includes: a transparent substrate; a detection electrode and a fingerprint detection circuit which are arranged on the transparent substrate, where the detection electrode includes a fingerprint detection electrode, the fingerprint detection circuit being connected to the fingerprint detection electrode and configured to drive the fingerprint detection electrode for fingerprint identification.

The panel directly integrates a fingerprint detection electrode and a fingerprint detection circuit. Therefore, as compared with the prior art, the display screen or the electronic device with the panel does not need to have an opening on the panel, thereby eliminating the need for aligning the opening and a fingerprint identification chip, which can result in a simple process and a low cost. In addition, since there is no need to make an opening on the panel, the problem of the panel being broken due to the opening is avoided.

In a panel according to the present disclosure, the transparent substrate includes a first surface and a second surface opposite to each other, and the first surface is a touch surface.

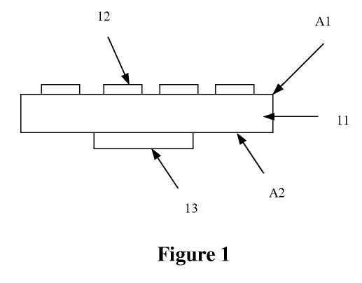

Reference is made to FIG. 1, which is a schematic structural diagram of a panel according to an embodiment of the present disclosure, the panel includes: a transparent substrate 11; a detection electrode 12 and a fingerprint detection circuit 13. The transparent substrate 11 includes a first surface A1 and a second surface A2 opposite to each other. The detection electrode 12 is arranged on the first surface A1. The fingerprint detection circuit 13 is arranged on the second surface A2. The detection electrode 12 includes a fingerprint detection electrode.

The fingerprint detection circuit 13 is connected to the fingerprint detection electrode via a flexible circuit board. Specifically, the fingerprint detection electrode is connected to a bonding pad in a bonding area via a lead wire, and the flexible circuit board has one end connected to the bonding pad and the other end connected to the fingerprint detection circuit on the second surface A2.

In the case where the panel is used in a display screen, the first surface A1 includes a display area and a border area. The detection electrode 12 on the display area is a transparent electrode, and the fingerprint detection circuit 13 is arranged on an area of the second surface that is opposite to the border area, in order to ensure display performance. Optionally, the fingerprint detection electrode is arranged on the border area.

In other embodiments, the fingerprint detection circuit 13 may be connected to the fingerprint detection electrode through a through-hole penetrating the transparent substrate 11. The hole penetrating the transparent substrate 11 is formed by such process as laser drilling, and is configured to connect the fingerprint detection electrode and the fingerprint detection circuit 13. In the case where the fingerprint detection circuit 13 is connected to the fingerprint detection electrode through a through-hole, the diameter of the formed through-hole ranges from 100 nm to 300 μm. The through-hole has a relatively small diameter, and can be made through the process of laser drilling, which will not lead to breaking of the glass substrate during drilling, and the mechanical performance of the silicon glass substrate after drilling will be less affected so that the substrate is not easily broken during use.

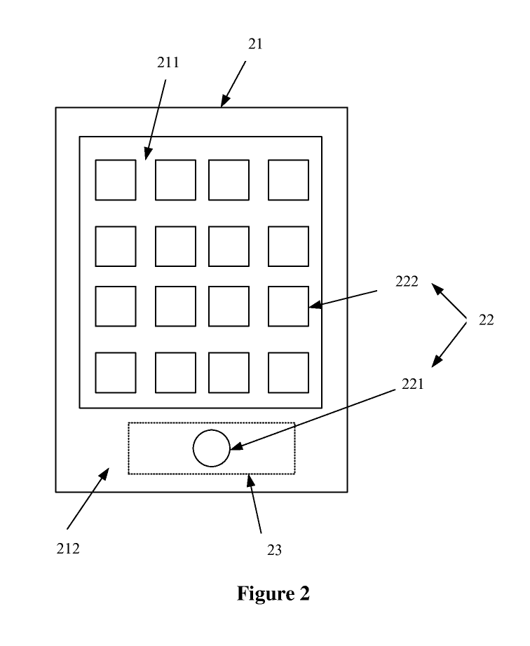

Reference is made to FIG. 2, which is a schematic structural diagram of a panel according to another embodiment of the present disclosure, the panel is used in an electronic device, including: a transparent substrate 21; and a detection electrode 22 and a fingerprint detection circuit 23 which are arranged on the transparent substrate 21. The detection electrode 22 includes a fingerprint detection electrode 221.

The transparent substrate 21 includes a first surface and a second surface opposite to each other. The first surface is a touch surface. The detection electrode 22 is arranged on the first surface for accurate touch sensing. The fingerprint detection circuit 23 is arranged on the second surface.

The first surface includes a display area 211 and a border area 212. The fingerprint detection electrode 221 is arranged in the border area 212. The fingerprint detection circuit 23 is arranged on the second surface and is opposite to the border area 212. Optionally, the fingerprint detection electrode 221 and the fingerprint detection circuit 23 are arranged oppositely to each other, in order to facilitate connecting them through a through-hole or via a flexible circuit board.

As shown in FIG. 2, in the panel according to the embodiment of the present disclosure, the detection electrode 22 further includes a common electrode 222. The panel further includes a common electrode driving circuit connected with the common electrode 222. The common electrode driving circuit may be arranged on the border area 212.

The common electrode 222 includes multiple electrode units insulated from each other, in order to realize display control and touch control. Specifically, the driving time of the common electrode 222 may be divided into alternating touch detection time intervals and display time intervals. In a touch detection time interval, a touch detection signal is provided to the common electrode 222, in order to realize touch detection by the common electrode 222. In a display time interval, a common voltage signal is provided to the common electrode 222, in order to realize display control by the common electrode 222.

In the panel according the embodiment of the present disclosure, the common electrode driving circuit may be arranged on the border area 212; in this case, the common electrode 222 and the common electrode driving circuit may be directly connected via a lead wire. In other embodiments, the common electrode driving circuit may be arranged on the second surface, and arranged oppositely to the border area 212; in this case, the common electrode 222 and the common electrode driving circuit may be connected through the a through-hole or via a flexible circuit board.

The common electrode 222 may be used for display control, or, for both display control and touch control. In the case where the common electrode 222 is used for display control only, the common electrode driving circuit is configured to provide a common voltage to the common electrode 222; in this case, the common electrode 222 is not limited to the structure that is shown in FIG. 2, but may have the structure of a whole plane electrode. In the case where the common electrode 222 is used for both display control and touch control, the common electrode driving circuit is configured to provide the common electrode 222 with the common voltage and the touch detection signal in a time-sharing way.

In the embodiment shown in FIG. 2, the fingerprint detection electrode 221 and the common electrode 222 are made on the same layer. The common electrode may double as a touch electrode.

In other embodiments, a separate touch detection electrode and a separate touch detection circuit may be used to realize touch detection. In this case, the detection electrode further includes a touch electrode. The panel further includes a touch detection circuit connected with the touch electrode. The touch detection circuit is configured to drive the touch electrode for touch detection.

The fingerprint detection electrode and the touch electrode may be made from the same metal layer. In this case, the fingerprint detection need not to be separately made, thereby eliminating the need of an additional process flow, which can result in a simple manufacture process and a low cost. Similarly, in order to ensure display performance, the detection electrode may be made from a transparent conductive layer, and the touch detection circuit may be arranged on the border area, or on an area of the second surface that is opposite to the border area.

In the case where the panel is used in a tablet computer or a mobile phone, the panel further includes a control button. The control button is arranged on the border area. In this case, the fingerprint detection electrode and the control button can be arranged oppositely to each other, in different metal conductive layers. Or, the fingerprint detection electrode surrounds the control button.

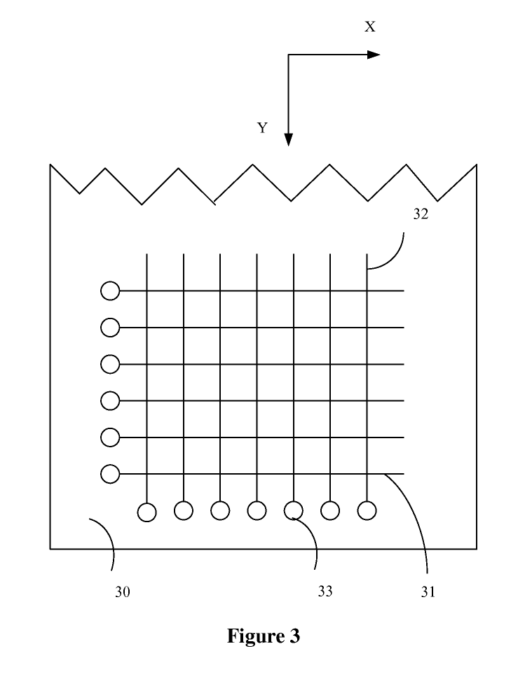

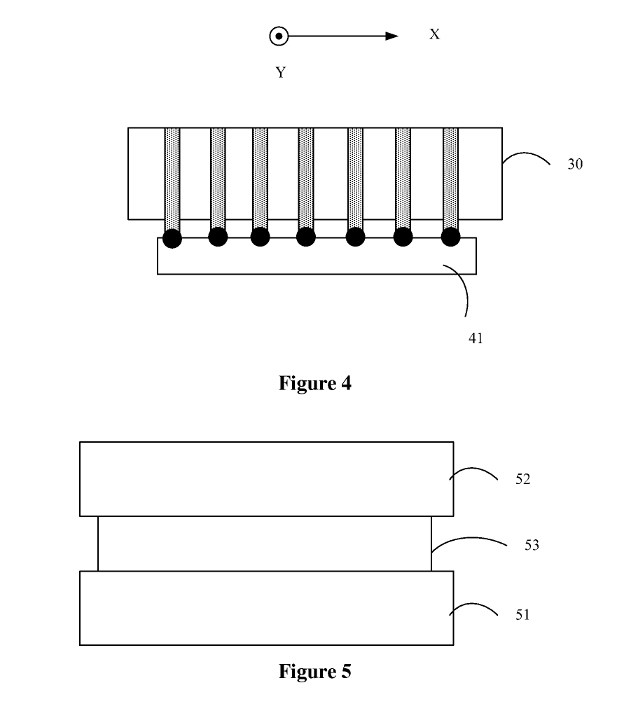

References are made to FIG. 3 and FIG. 4, where FIG. 3 is a schematic structural diagram of a fingerprint detection electrode according to an embodiment of the present disclosure, and FIG. 4 is a sectional view taken along a first direction X of FIG. 3.

A transparent substrate 30 includes a first surface and a second surface opposite to each other. In the embodiment in FIG. 3, only a part of the transparent substrate 30 that includes a fingerprint detection electrode is shown, and a broken line indicates that the transparent substrate 30 is partially shown.

The fingerprint detection electrode includes: a first electrode 31 extending in a first direction X; and a second electrode 32 extending in a second direction Y. The first direction X is perpendicular to the second direction Y, and the first electrode 31 is insulated from the second electrode 32. The fingerprint detection electrode is arranged on the first surface. Through-holes 33 penetrating the transparent substrate 30 are provided on both one end of the first electrode 31 and one end of the second electrode 32.

A fingerprint detection circuit 41 is arranger on the second surface. The fingerprint detection circuit 41 can be directly formed on the second surface, or mounted onto the second surface by using an integrated chip. The first electrode 31 and the second electrode 32 are connected to the fingerprint detection circuit 41 through corresponding through-holes.

The first electrode 31 and the second electrode 32 can be made from different metal layers. Specifically, the first electrode may be made from a first metal layer, and the second electrode may be made from a second metal layer, where there is an insulating layer between the first metal layer and the second metal layer.

In the case where the structure of the fingerprint detection electrode shown in FIG. 3 is used, if the fingerprint detection electrode and a touch electrode constitute the detection electrode, optionally, the touch detection electrode has a double metal layer structure, so that the two can be made together; therefore, there is no need to add an additional process flow in the making of the fingerprint detection electrode, and manufacture cost will not be increased.

In other embodiments, the first electrode includes a first part in the same layer as the second electrode and a second part crossing the second electrode. The first part is in the same layer as the second electrode, and there is an insulating layer between the second part and the second electrode. In this case, where the first electrode and the second electrode cross is insulated by a bridging-over structure.

In the case where the fingerprint detection electrode adopts a bridging-over structure, if the fingerprint detection electrode and the touch electrode constitute the detection electrode of the panel, preferably, the touch electrode adopts the same bridging-over structure as the fingerprint detection electrode, so that the touch electrode and the fingerprint detection electrode can be made together, thereby reducing the cost.

The common electrode is made from a transparent metal layer; in the case where the fingerprint detection electrode and the common electrode constitute the detection electrode, one of the first electrode 31 and the second electrode 32 may be made on the same layer as the common electrode, with the other one being made additionally, which can also reduce the manufacture cost.

It can be seen from the above description that, in the panel according to the embodiments of the present disclosure, the fingerprint detection electrode and the fingerprint detection circuit are arranged on the same transparent substrate, which can result in a low manufacture cost and ensure a relatively good mechanical strength of the panel, as compared with the design method in the prior art where the fingerprint detection chip is arranged on a back plate, the fingerprint detection electrode is arranged on the panel, and an opening is formed on the panel.

A display screen is also provided according to an embodiment of the present disclosure, with reference to FIG. 5, which is a schematic structural diagram of a display screen according to an embodiment of the present disclosure. The display screen includes: a back plate 51 and a panel 52 opposite to each other; and a display module 53 arranged between the back plate 51 and the panel 52. The panel may be one of the panels described in the above embodiments.

The display screen according to an embodiment of the present disclosure using one of the panels described in the above embodiments, as compared with the prior art, does not require accurate alignment between the opening and the fingerprint detection chip on the back plate, which can result in a low manufacture cost and a simple manufacture process.

An electronic device is also provided according to an embodiment of the present disclosure, the electronic device including one of the display screens in the above embodiments. The electronic device may be an electronic device with a touch display screen such as a computer and a mobile phone. The electronic device according to the embodiment of the present disclosure uses the above display screen, which can result in a simple manufacture process and a low cost.

The above description of the embodiments herein enables those skilled in the art to implement or use the present disclosure. Various modifications to these embodiments will be apparent to those skilled in the art, and the general principle defined herein can be implemented in other embodiments without departing from the spirit or scope of the present disclosure. Therefore, the present disclosure is not limited to the embodiments described herein, but in accordance with the widest scope consistent with the principle and novel features disclosed herein.

1. A panel for an electronic device, comprising:
a transparent substrate;
a detection electrode and a fingerprint detection circuit, which are arranged on the transparent substrate,
wherein the detection electrode comprises a fingerprint detection electrode, the fingerprint detection circuit being connected to the fingerprint detection electrode and configured to drive the fingerprint detection electrode for fingerprint identification.

2. The panel according to claim 1, wherein the transparent substrate comprises a first surface and a second surface opposite to each other, the first surface being a touch surface,
wherein the detection electrode is arranged on the first surface, and the fingerprint detection circuit is arranged on the second surface.

3. The panel according to claim 2, wherein the fingerprint detection circuit is connected to the fingerprint detection electrode via a flexible circuit board; or,
the fingerprint detection circuit is connected to the fingerprint detection electrode through a through-hole penetrating the transparent substrate.

4. The panel according to claim 2, wherein the first surface comprises a display area and a border area surrounding the display area,
wherein the fingerprint detection electrode is arranged on the border area, and the fingerprint detection circuit is arranged on the second surface and is opposite to the border area.

5. The panel according to claim 4, wherein the detection electrode further comprises a common electrode; and
the panel further comprises a common electrode driving circuit connected with the common electrode.

6. The panel according to claim 5, wherein the common electrode driving circuit is arranged on the border area; or,
the common electrode driving circuit is arranged on an area of the second surface that is opposite to the border area.

7. The panel according to claim 5, wherein the common electrode driving circuit is configured to provide a common voltage to the common electrode; or,
the common electrode driving circuit is configured to provide the common electrode with the common voltage and a touch detection signal in a time-sharing way.

8. The panel according to claim 4, wherein the detection electrode further comprises a touch electrode, and the panel further comprises a touch detection circuit connected with the touch electrode, the touch detection circuit being configured to drive the touch electrode for touch detection.

9. The panel according to claim 8, wherein the touch detection circuit is arranged on the border area; or,
the touch detection circuit is arranged on an area of the second surface that is opposite to the border area.

10. The panel according to claim 4, wherein the panel further comprises a control button arranged on the border area,
wherein the fingerprint detection electrode and the control button are arranged oppositely to each other, or, the fingerprint detection electrode surrounds the control button.

11. The panel according to claim 1, wherein the fingerprint detection electrode further comprises a first electrode extending in a first direction and a second electrode extending in a second direction,
wherein the first direction is perpendicular to the second direction, and the first electrode is insulated from the second electrode.

12. The panel according to claim 11, wherein the first electrode is made from a first metal layer, and the second electrode is made from a second metal layer,
wherein there is an insulating layer between the first metal layer and the second metal layer.

13. The panel according to claim 11, wherein the first electrode comprises a first part in the same layer as the second electrode and a second part crossing the second electrode,
wherein the first part is in the same layer as the second electrode, and there is an insulating layer between the second part and the second electrode.

14. A display screen, comprising:
a back plate and a panel opposite to each other, and
a display module arranged between the back plate and the panel,
wherein the panel comprises:
a transparent substrate;
a detection electrode and a fingerprint detection circuit, which are arranged on the transparent substrate,
wherein the detection electrode comprises a fingerprint detection electrode, the fingerprint detection circuit being connected to the fingerprint detection electrode and configured to drive the fingerprint detection electrode for fingerprint identification.

15. An electronic device comprising a display screen;
wherein the display screen comprises:
a back plate and a panel opposite to each other, and
a display module arranged between the back plate and the panel,
wherein the panel comprises:
a transparent substrate;
a detection electrode and a fingerprint detection circuit, which are arranged on the transparent substrate,
wherein the detection electrode comprises a fingerprint detection electrode, the fingerprint detection circuit being connected to the fingerprint detection electrode and configured to drive the fingerprint detection electrode for fingerprint identification.
